(19) United States
(12) Patent Application Publication
(10) Pub. No.: US 2008/0271518 A1
(43) Pub. Date: Nov. 6, 2008

(54) Gas Sensor

(76) Inventors: Christoph Treutler, Wannweil (DE); Ralf Schmidt, Gerlingen (DE); Stefan Henneck, Leonberg (DE); Hans-Joerg Renz, Leinfelden-Echterdingen (DE); Uwe Glanz, Asperg (DE); Leonore Schwegler, Stuttgart (DE); Juergen Ruth, Stuttgart (DE); Juergen Sindel, Vaihingen/Enz (DE); Stefan Nufer, Stuttgart (DE); Henrik Schittenhelm, Stuttgart (DE); Georg Rixecker, Leinfelden-Echterdingen (DE)

Correspondence Address: KENYON & KENYON LLP, ONE BROADWAY, NEW YORK, NY, 10004, US

(21) Appl. No.: 11/793,057

(22) PCT Filed: Oct. 7, 2005
(86) PCT No.: PCT/EP2005/055082

§ 371 Date: Apr. 3, 2008

(30) Foreign Application Priority Data
Dec. 29, 2004 (DE) 10 2004 063 168.9

(51) Int. Cl. G01N 27/00; G01N 7/00

(52) U.S. Cl. 73/23.31; 73/31.05

(57) ABSTRACT

A gas sensor, in particular for determining the oxygen content in exhaust gases of internal combustion engines, having a housing, a sensor element having a multi-layer design which is situated in the housing, and connecting lines lead to the outside for contacting the sensor element. A contacting element of a connecting line penetrates a layer of the sensor element and part of an insulating element situated outside the sensor element. For contacting the sensor element, such a contact configuration makes it possible to directly contact the contacting element of the connecting line, which may be arranged as a contacting pin, to the printed conductor which is formed inside the sensor element.

### FIELD OF THE INVENTION

The present invention relates to a gas sensor, in particular for determining the oxygen content in exhaust gases of internal combustion engines.

### BACKGROUND INFORMATION

Two such gas sensors are based on the unexamined German patent applications DE 41 26 378 A1 and DE 198 03 334 A1, which are also from the same Applicant. These two gas sensors are built from a large number of individual parts, which must be put together with corresponding effort. The manufacturing costs of such gas sensors are thus dependent in part on both the number of components and the number of production steps required.

### SUMMARY OF THE INVENTION

An object of the exemplary embodiment and/or exemplary method of the present invention is therefore to reduce the costs of manufacturing such gas sensors.

This object may be achieved through the features described herein.

The further features described herein indicate advantageous and expedient refinements of the exemplary embodiment and/or exemplary method of the present invention.

The exemplary embodiment and/or exemplary method of the present invention is directed to a gas sensor, in particular for determining the oxygen content in exhaust gases from internal combustion engines. The core of the exemplary embodiment and/or exemplary method of the present invention is the fact that a contact element of a connecting line penetrates a layer of the sensor element and a part of an insulating element situated outside of the sensor element.

Such a contact construction makes it possible to connect the contact element of the connecting line, which may be designed for example as a contact pin, to connect the sensor element directly to the printed conductor formed in the interior of the sensor element. Connection contacts that were formerly necessary on the outer surface of the sensor elements for contact connection with the connecting lines exiting the gas sensor may thus be eliminated, together with their connections to the printed conductor, which must be insulated. Hence this results in a reduction of the number of components and procedural steps to manufacture and install them.

In addition, such a contact construction results in an additional advantage, to the effect that formerly known insulation problems are eliminated, at high temperatures in particular. These insulation problems result in part from the fact that the layers of the sensor element surrounding the printed conductors are used as supports for the connection between the printed conductor and the externally situated connection contact, but that these become conductive to a greater or lesser degree at high temperatures, depending on the composition of the material.

In contrast, through the contact construction proposed according to the exemplary embodiment and/or exemplary method of the present invention, the contact element of a connecting line for connecting with a sensor element printed conductor may be connected to directly touch the latter, in which case an opening of sufficient size is made in the layer of the sensor element covering the printed conductor. That leaves sufficient free space around the contact element of the connecting line, which ensures in any case that no touching may occur between these two, not even if the contact element is made of a ductile material, and the dimensions of the contact element become enlarged in this penetration through the sensor element layer due to the effect of appropriate deforming forces to achieve the best possible contact.

To increase the contact surface and/or to improve the process flow in connecting the printed conductor with the contact element of the connecting line, a specific embodiment may provide for example that the contact element be formed of multiple parts. For example, in a two-part design of the contact element there may be a sleeve situated around a contact pin on the side facing the printed conductor, which results in an enlargement of the contact surface between the contact element and the printed conductor.

The contact pin and the sleeve may be matched to each other in such a way that on the one hand they are easily connectable to each other, and on the other hand this connection is so strong that it withstands certain tensile effects without problem. Such a tensile effect may occur for example when installing the insulating element in a housing, where the insulating element is held in place in the housing by the contact element and a connecting line connected to it.

In a specific embodiment modified from the above, the contact may be designed so that it is firmly connectable to the circuit board through bonding. For example, it may be designed as a sleeve with or without a closed bottom, which is placed on end on the circuit board and is connected to the latter using a laser beam that fuses the two materials together. For this contact element design as well, it is provided that the through passage in the sensor element layer be sufficiently large so that the contact does not touch it.

Of course, additional layers subsequently placed further outward on the sensor element are also provided with appropriately large through passages, for example if the printed conductor is formed in a deeper layer of the sensor element. In such a case the contact element penetrates a plurality of layers of the sensor element, which may not be touching a single one of these layers.

It is regarded as particularly advantageous for the insulating element to be suitably designed for insulating the contact element from at least one layer of the sensor element. For example, to that end the insulating element may project into the through passage, so that it reduces the inner cross section of this through passage for the contact element of a connecting line situated in it, and thus separates and insulates these two from each other.

There may at the same time be a positioning and/or fixing element situated on the insulating element, or even formed on it. That enables either the insulating element itself or indirectly the contact element of the connecting line to be guided and positioned in the through passage of the sensor element layer.

By forming a contact element receptacle on the insulating element, the possibility even exists of prefabricatingly joining contact elements with the insulating element prior to installation in a housing. The contact element receptor may be arranged so that the contact element inserted into it is sufficiently secured so that it will not fall out during assembly.

In an exemplary embodiment it may be provided that the insulating element is of sufficiently sturdy design so that it is suitable for transmitting a pressing force to a contact element. This is particularly advantageous with specific embodiments in which contact is made by compressing a housing having sensor elements situated in it.

Such a pressing force may be produced for example by a spring element. To that end the housing may be made for example of a spring steel which is appropriately pre-shaped to firmly hold a sensor element. To receive the sensor element, the housing is sufficiently deformed with a force temporarily acting on it so that the sensor element can be introduced and appropriately positioned. This force temporarily acting on the housing is then removed again, and the housing may act elastically on the inserted sensor element having the insulating and contact elements situated on it, clamping them together.

Another possibility for clamping is for example a permanent deformation of a tubular housing body at the correspondingly suitable places, which may be in the area of the contacting.

The insertion of the contact element into the insulating element may be further simplified in particular by also having a positioning and/or fixing element situated or even formed on the contact element. Especially well suited for that are conically shaped contours, since these have good guiding properties and are also excellently suited for transmitting forces between two adjacent elements.

It may furthermore be advantageous if there is also a positioning and/or fixing element situated on the sensor element. Such a feature may be realized for example by beveling the leading edge area of the penetration through a planar layer of the sensor element. That enables both the contact element of the connecting line and the insulating element to be better guided and positioned during assembly, and also held, when the touching parts are appropriately shaped.

According to the exemplary embodiment and/or exemplary method of the present invention this therefore results in a contact construction in which the area to be contacted is formed in the interior of the sensor element on the bottom of a recess in a sensor element layer, which may be the printed conductor. Through a tapering formed on the contact pin, when the housing is clamped, the contact pin may receive a deforming force from the insulating element from what may be a complementary contour through appropriately shaped shoulders, and thus be pressed against the printed conductor, making good contact. In particular, that also makes it possible to secure the particular contact pin in the insulating element in a gas-tight manner. In addition, in this clamping process it is also possible to carry out the necessary connection of the contact pin with the corresponding connecting line in one process step.

### BRIEF DESCRIPTION OF THE DRAWINGS

FIG. 1 shows an oblique exploded top view of elements of a gas sensor.

FIG. 2 shows an oblique top view of a housing of a gas sensor with attached cable harness and a sensor element to be inserted into the housing for contacting.

FIGS. 3, 3a and 3b show a top view and partial cross-sectional views of a contact system according to the exemplary embodiment and/or exemplary method of the present invention for contact connection of a sensor element directly on a printed conductor formed in the interior of the sensor element, before making contact.

FIGS. 4, 4a and 4b show a top view and partial cross-sectional views of a contact system according to the exemplary embodiment and/or exemplary method of the present invention for contact connection of a sensor element directly on a printed conductor formed in the interior of the sensor element, after making contact.

FIG. 5 shows a cross section through an insulating element that is suitably designed for receiving a contact element for a connecting line.

FIGS. 5a-5c show contact elements.

FIG. 6 shows a cross section through an insulating element that is suitably designed for receiving a contact element for a connecting line.

FIGS. 6a-6c show contact elements.

### DETAILED DESCRIPTION

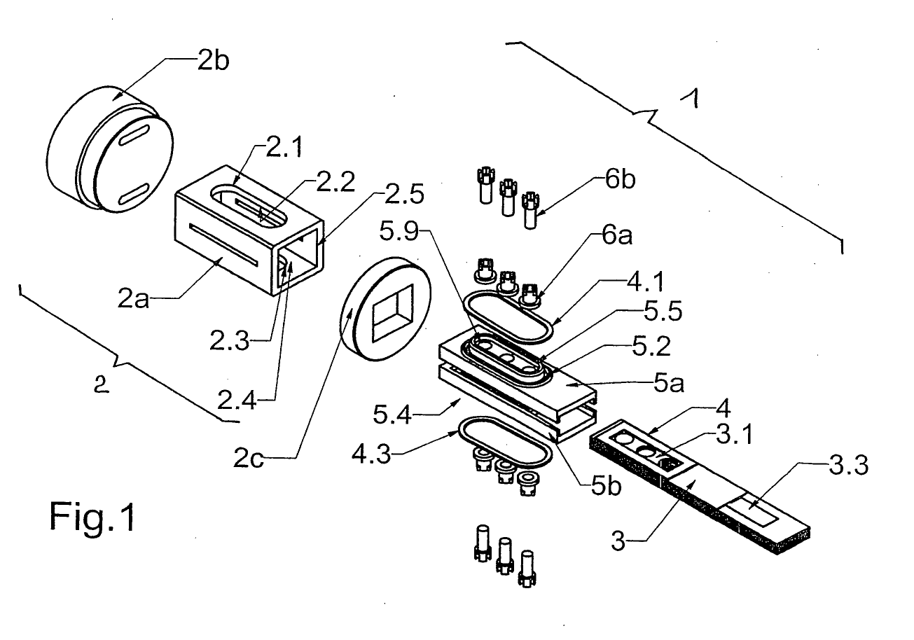

FIG. 1 shows an oblique exploded top view of elements of a gas sensor 1. A housing 2 is shown, in which a sensor element 3 is to be fixed by a fixing element 5.

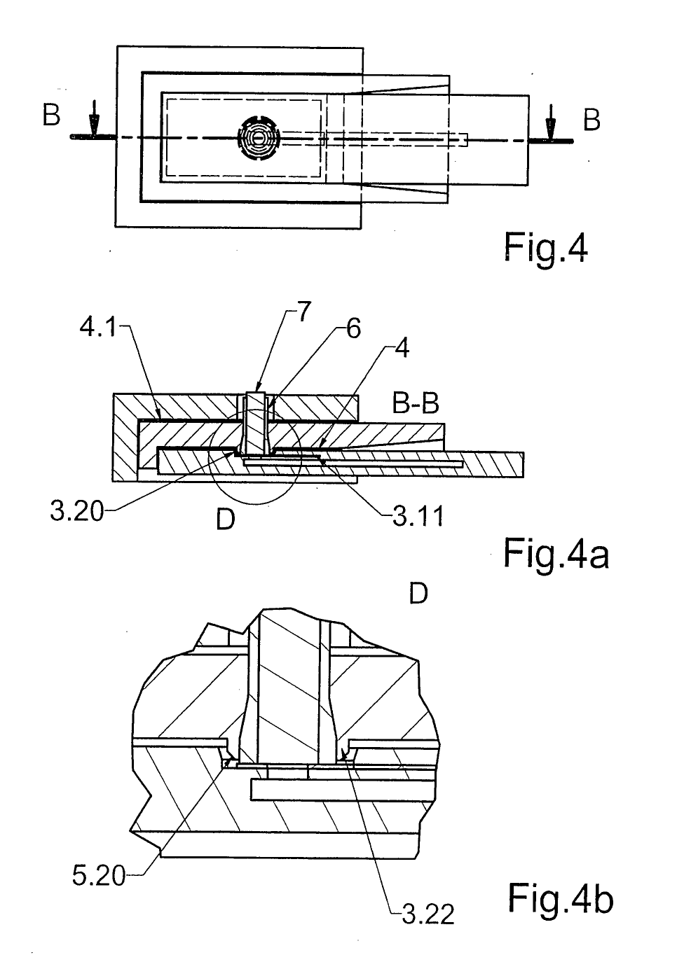

It is provided according to the exemplary embodiment and/or exemplary method of the present invention that contact elements 6 for connecting lines that are to be routed out of housing 2 are placed in contact directly with the printed conductors formed in the interior of the sensor element. To that end it is provided that fixing element 5 is designed as an insulating element 5, a contact element 6 of a connecting line penetrating both insulating element 5, which is situated outside of sensor element 3, and a layer of sensor element 3 (see FIG. 4), but without touching this sensor element layer.

In FIG. 1 there are contact openings 5.9 in insulating element 5, through which contacts 6 may be routed to make contact with contact zone 3.1 of sensor element 3. Contacts 6 are depicted in two parts. They are made of a part 6a to be situated in the interior of insulating element 5, and a second contact part 6b to be passed from outside through contact opening 5.9 and connected with part 6a.

For the sake of completeness, seals 4, 4.1, 4.3 and sealing zones 5.2, 5.4 on insulating element 5 assigned to them, as well as sealing zones 2.2 and 2.4 on the housing, are referenced. They provide gas-tight isolation of a measured gas zone from a reference gas zone of the gas sensor.

On shell-shaped fixing element 5 there is a fixing aid 5.5 formed on the outer bottom of the shell. This is intended for engaging an opening 2.1 of housing 2. The housing itself is constructed in a single piece when assembled, so that parts 2a, 2b, 2c form a combined unit.

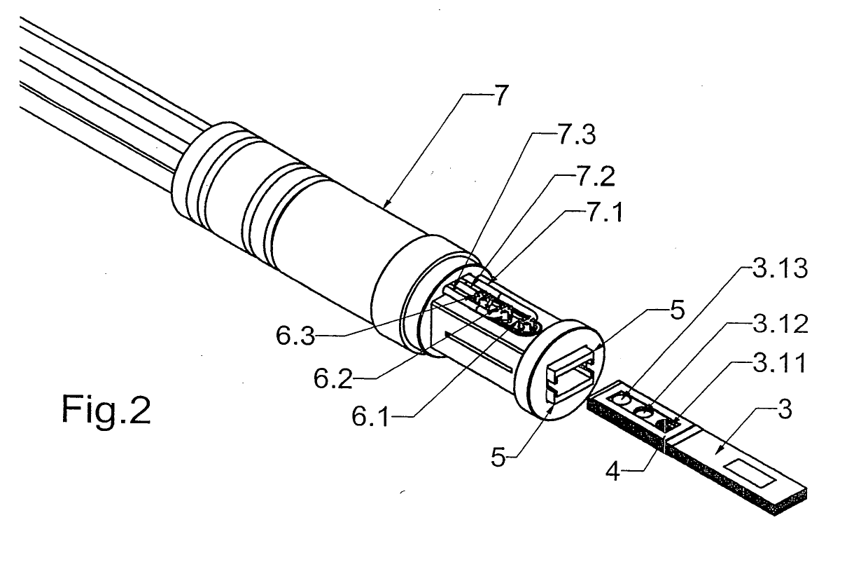

FIG. 2 shows a preassembled housing 2 with cable harness 7 attached to it, ready to receive sensor element 3 and to perform the contacting according to the exemplary embodiment and/or exemplary method of the present invention. Connecting lines 7.1 through 7.3 are connected with contacts 6.1 through 6.3, which in turn are in direct contact with printed conductors 3.11 through 3.13 of the sensor element in the interior of the sensor element.

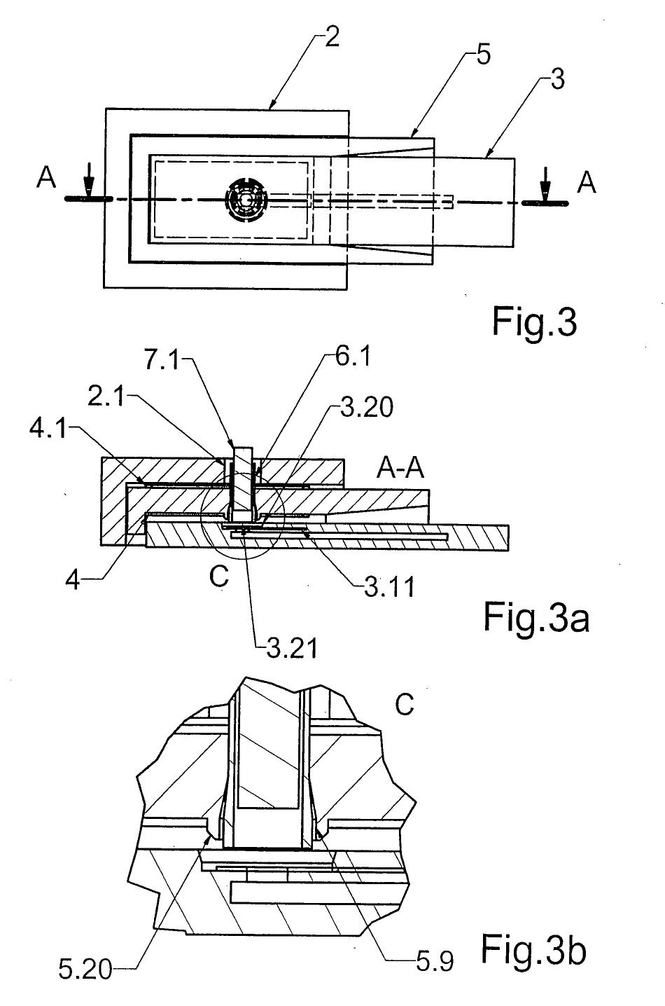

FIG. 3 shows a top view of, and FIG. 3a a partial cross-sectional depiction through, a contact zone of a sensor element 3 inserted into a housing 2, before the positioning and securing procedure to produce the contact connection according to the exemplary embodiment and/or exemplary method of the present invention. FIGS. 4 and 4a show the same system after securing of the sensor element in the housing to produce the contacting according to the exemplary embodiment and/or exemplary method of the present invention.

In order to be able to implement the best possible contacting between contact element 6 and printed conductor 3.11 via direct contact in a material-compatible manner, contact element 6 may be manufactured of a ductile material. When housing 2 is compressed with sensor element 3 situated in it, contact 6 may then be deformed, which brings about both a good contact with the printed conductor and a good fixing effect of contact element 6 in insulating element 5. This effect is evident in particular from a comparison of the two details in FIGS. 3b and 4b.

In FIG. 3a, the contact element made up of the two parts 6a and 6b is received loosely in contact opening 5.9. There is still ample clearance between the contact element and the internal wall of contact element receptacle 5.9 in insulating element 5.

In the depiction in FIG. 4a, in contrast, contact 6 is so firmly secured that it fills the internal contours of contact opening 5.9. In addition, a rounded outside contour of contact 6 is depicted in a through passage 3.21 in a sensor element layer, in order to show the deformation of contact 6. Through passage 3.21 is made large enough here so that even with the depicted deformation of contact 6 the latter does not touch the pertinent sensor element layer.

Contact 6 is touching only insulating element 5, which for its part forms an additional insulation from the sensor element layer for contact 6 by its centering lug 5.20.

In addition, this centering lug 5.20 also has the function of a positioning and/or fixing element, which has a positive effect both on insulating element 5 and on contact 6 when producing the contacting according to the exemplary embodiment and/or exemplary method of the present invention.

To prevent excessive mechanical stresses, which can damage the sensor element, a ductile property of the contact element is utilized in order to form an appropriate elastic connection in contacting.

For the compression of the housing the sensor element, in a first specific embodiment the housing may be made of spring steel. To set the sensor element, it is first re-shaped from its given form, the sensor element is inserted, and then it is released again to resume its shape. The result is a spring-loaded contact connection.

In another specific embodiment, housing 2 may be made for example of rectangular tubing, as shown in FIG. 1, which may be compressed by external force to produce the contact connection according to the exemplary embodiment and/or exemplary method of the present invention, after being populated with the sensor element, insulating element 5, and contacts 6.

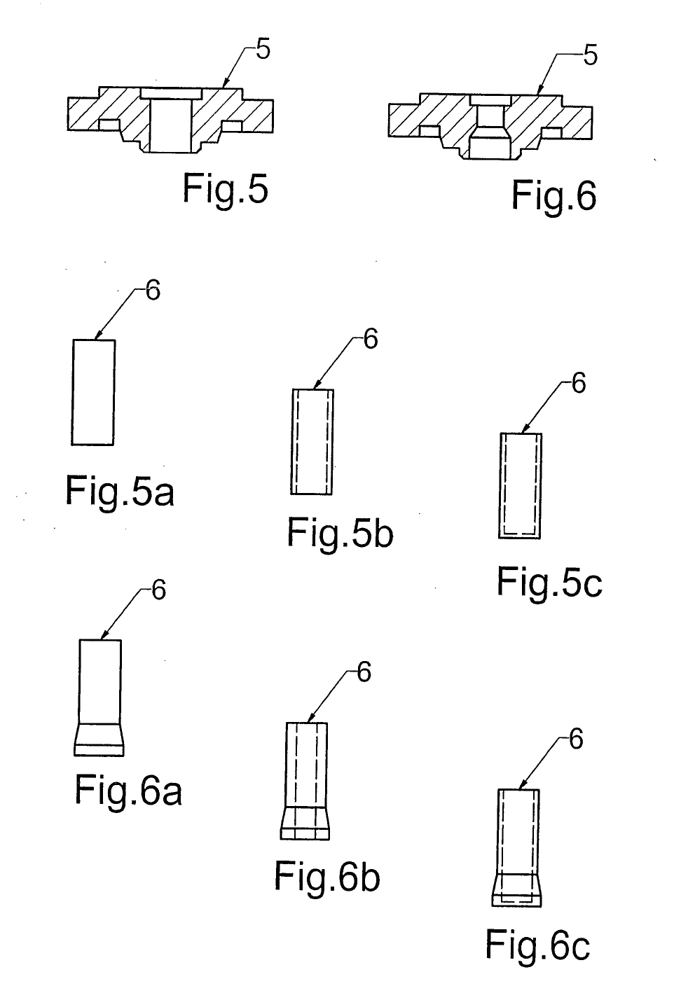

FIGS. 5 and 6 show two different specific embodiments of insulating elements 5 in cross section through a contact opening 5.9. FIGS. 5a through 5c show various types of contacts that are suitable for being received in insulating element 5 according to FIG. 5. FIGS. 6a through 6c show corresponding types of contacts 6 that are suitably designed for being received in insulating element 5 according to FIG. 6.

In this specific embodiment also, contact opening 5.9 in insulating element 5 and opening 3.21 in the applicable insulating element layer are situated and designed in relation to each other in such a way that contact 6 may be connected satisfactorily with printed conductor 3.11 through a bonding process, without the contact being able to touch the sensor element layer. Hence in this specific embodiment as well, an insulating zone 3.22 is formed in opening 3.21 around contact 6, which is in contact with printed conductor 3.11.

1-11. (canceled)

12. A gas sensor comprising:
a housing;
a sensor element built up in multiple layers situated in the housing; and
outward-leading connecting lines in the housing for contacting the sensor element,
wherein a contact element of at least one of the connecting lines penetrates a layer of the sensor element and a part of an insulating element situated outside of the sensor element.

13. The gas sensor of claim 12, wherein a contact element directly contacts a sensor element printed conductor.

14. The gas sensor of claim 13, wherein the contact element is made of ductile material.

15. The gas sensor of claim 13, wherein the contact element is formed of multiple parts.

16. The gas sensor of claim 12, wherein the insulating element insulates a contact element from at least one layer of the sensor element.

17. The gas sensor of claim 12, wherein at least one of a positioning element and a fixing element is situated on the insulating element.

18. The gas sensor of claim 12, wherein a contact element receptacle is formed on the insulating element.

19. The gas sensor of claim 12, wherein the insulating element is for transmitting a pressing force to a contact element.

20. The gas sensor of claim 12, further comprising:
a spring element for introducing a pressing force at least one of onto the insulating element and onto the contact element.

21. The gas sensor of claim 12, wherein at least one of a positioning element and a fixing element is situated on the contact element.

22. The gas sensor of claim 12, wherein at least one of a positioning element and a fixing element is situated on the sensor element.

23. The gas sensor of claim 12, wherein the sensor is for determining an oxygen content in an exhaust gas of an internal combustion engine.
